(19) United States
(12) Patent Application Publication
(10) Pub. No.: US 2017/0033398 A1
(43) Pub. Date: Feb. 2, 2017

(54) ELECTRODE ASSEMBLY, ALL-SOLID STATE SECONDARY BATTERY, AND METHOD FOR PRODUCING ELECTRODE ASSEMBLY

(71) Applicant: SEIKO EPSON CORPORATION, Tokyo (JP)

(72) Inventor: Tomofumi YOKOYAMA, Matsumoto-shi (JP)

(73) Assignee: SEIKO EPSON CORPORATION, Tokyo (JP)

(21) Appl. No.: 15/195,044

(22) Filed: Jun. 28, 2016

(30) Foreign Application Priority Data
Jul. 30, 2015 (JP) 2015-150423

(51) Int. Cl. H01M 10/0525; H01M 4/04; H01M 4/525; H01M 4/52; H01M 10/0562; H01M 4/131

(52) U.S. Cl. CPC H01M 10/0525; H01M 10/0562; H01M 4/131; H01M 4/525; H01M 4/523; H01M 4/0471; H01M 2004/021

(57) ABSTRACT

A positive electrode layer as an electrode assembly includes an active material portion which contains a transition metal oxide as an active material and a solid electrolyte portion which is in contact with the active material portion and contains an ion conductive solid, and the crystal plane orientation of a crystal plane of the transition metal oxide and the crystal plane orientation of a crystal plane of the ion conductive solid substantially coincide with each other and are oriented in the thickness direction of the positive electrode layer.

This application claims a priority to Japanese Patent Application No. 2015-150423 filed on Jul. 30, 2015 which is hereby expressly incorporated by reference in its entirety.

### BACKGROUND

1. Technical Field

Several aspects of the present invention relate to an electrode assembly, an all-solid state secondary battery, and a method for producing an electrode assembly.

2. Related Art

As a power supply for portable information terminals such as smartphones and notebook-type personal computers, a lithium-ion secondary battery which can be charged and discharged, and also has a relatively large battery capacity has been used. On the other hand, a lithium-ion secondary battery using an electrolyte including an electrolytic solution contains a flammable solvent in the electrolytic solution, and therefore has been required to ensure safety.

In order to increase the safety of a battery, the development of a lithium-ion secondary battery using a solid electrolyte has advanced. For example, WO 2011/102054 (PTL 1) discloses an all-solid state secondary battery which includes a positive electrode, a negative electrode, and a solid electrolyte sandwiched between these electrodes, and is composed of a molded body produced by compression-molding a powder of a carbon material of an electrode active material of the positive electrode or the negative electrode or both electrodes at a pressure of 110 MPa. Further, it is described that the ratio (P₀₀₂:P₁₀₀) of the X-ray diffraction peak intensity P₀₀₂ in the (002) plane obtained when irradiating the surface of the molded body with an X-ray to the X-ray diffraction peak intensity P₁₀₀ in the (100) plane is 600 or less. It is described that according to this, the orientation of the crystal plane in the surface of the molded body is controlled, and therefore, an all-solid state secondary battery which can be charged and discharged without causing a short circuit even at a high current density and has excellent rate characteristics can be realized. That is, it is indicated that the orientation of the crystal plane in the interface between an electrode layer and an electrolyte layer has an influence on the battery performance.

According to a method for producing an all-solid state secondary battery disclosed in the above-mentioned PTL 1, a positive electrode mixture powder is charged on one side of a solid electrolyte layer obtained by compression-molding a solid electrolyte material, and a negative electrode mixture powder containing a carbon material powder is charged on the other side thereof, followed by compression at a given pressure, whereby a battery pellet is formed. Then, it is described that the charge-discharge rate characteristics are superior in the case of Examples 1 to 4 in which the orientation of the surface of a carbon pellet constituting the negative electrode is low to the case of Comparative Examples 1 and 2 in which the orientation of the surface of the carbon pellet is high. In addition, it is described that the charge-discharge rate characteristics are superior in the case of Examples 1 to 3 in which the orientation of the surface of a mixed pellet containing a carbon material powder and a solid electrolyte powder is low to the case of Example 4 and Comparative Examples 1 and 2 in which the orientation of the surface of the mixed pellet is high.

In this manner, in the PTL 1, the control of the orientation of the surface of the mixed pellet is important for obtaining an all-solid state secondary battery having excellent rate characteristics, however, it is not clearly described about the influence of the orientation of a carbon material having electron conductivity in the inside of the mixed pellet and the orientation of a solid electrolyte having ion conductivity on the rate characteristics. In other words, it has a problem that a more preferred crystal structure in a molded body obtained by mixing an electrode material and a powder of a solid electrolyte material is required to be realized.

Further, in the case where the molded body is formed by compression, it is preferred to use a relatively soft material as the solid electrolyte, and in the above-mentioned PTL 1, a material containing a sulfide is described as an example. However, when a molded body is formed using a solid electrolyte containing a sulfide, there is a risk that, for example, a toxic gas such as hydrogen sulfide is generated.

In addition, in the case where the positive electrode contains, for example, a heavy metal such as iron (Fe), manganese (Mn), cobalt (Co), or nickel (Ni), there is a risk that the heavy metal is dissolved in the sulfide to increase the electrical resistance of the positive electrode.

### SUMMARY

An advantage of some aspects of the invention is to solve at least a part of the problems described above, and the invention can be implemented as the following embodiments or application examples.

### Application Example

An electrode assembly according to this application example is an electrode assembly to be used in an all-solid state secondary battery and includes an active material portion which contains a transition metal oxide as an active material, and a solid electrolyte portion which is in contact with the active material portion and contains an ion conductive solid, wherein the crystal plane orientation of the transition metal oxide and the crystal plane orientation of an ion diffusion plane of the ion conductive solid substantially coincide with each other.

According to this application example, the crystal plane orientation of a crystal plane including an electrode reaction site where charge can be exchanged in the active material portion and the crystal plane orientation of an ion diffusion plane of the ion conductive solid substantially coincide with each other, and therefore, the crystal plane with high electrode reaction activity of the active material portion and the crystal plane of the ion conductive solid in which ion diffusion is easy to occur are in the same phase and therefore are easily connected to each other. Therefore, an electrode assembly which promotes the charge exchange reaction and can realize an all-solid state secondary battery capable of obtaining high output energy can be provided.

In the electrode assembly according to the application example, it is preferred that with respect to the thickness direction of the electrode assembly, the crystal plane (hkl) of the transition metal oxide and the crystal plane (hkl) of the ion conductive solid are both (001)-oriented.

According to this configuration, the crystal plane is in an oriented state where a charge (an ion or an electron) is easy to move in the thickness direction of the electrode assembly, and therefore, the charge exchange reaction rate is improved. Incidentally, h, k, and 1 which represent the crystal plane (hkl) are each a positive integer.

In the electrode assembly according to the application example, it is preferred that the transition metal oxide contains Li (lithium) and Co (cobalt), and the ion conductive solid contains Li (lithium), B (boron) C (carbon) and O (oxygen).

According to this configuration, an electrode assembly capable of promoting the charge exchange reaction by using a multiple metal oxide containing Li and Co as the active material can be provided. Further, the ion conductive solid containing Li (lithium), B (boron), C (carbon) and O (oxygen) melts at a low temperature which is lower than 1000° C. and is about 700° C., and therefore, it is easy to combine the active material portion and the ion conductive solid.

In the electrode assembly according to the application example, it is preferred that the ratio (P₀₂₀:P₀₀₂) of the X-ray diffraction peak intensity P₀₂₀ in the (020) plane of the ion conductive solid to the X-ray diffraction peak intensity P₀₀₂ in the (002) plane thereof is 1:20 or less.

According to this configuration, the (020) plane with higher ion diffusivity than the (002) plane can be oriented to the direction of the electrode reaction site orthogonal to the crystal plane of the active material portion, and therefore, the charge exchange reaction rate is further improved.

In the electrode assembly according to the application example, it is preferred that the active material portion is a porous body, and part of the solid electrolyte portion is filled in gaps of the porous body, whereby the active material portion and the solid electrolyte portion are in contact with each other.

According to this configuration, the active material portion and the solid electrolyte portion are combined with each other by introducing the ion conductive solid into gaps of the porous body, and therefore, an electrode assembly having a high electric capacity density can be provided.

In the electrode assembly according to the application example, it is preferred that the bulk density porosity of the active material portion is 35% or more and 60% or less.

According to this configuration, an electrode assembly which realizes a high electric capacity density, and also can ensure a mechanical strength can be provided.

### Application Example

An all-solid state secondary battery according to this application example is an all-solid state secondary battery which includes a positive electrode layer, a negative electrode layer, and a solid electrolyte layer sandwiched between the positive electrode layer and the negative electrode layer, wherein at least one of the positive electrode layer and the negative electrode layer includes the electrode assembly according to the application example.

According to this application example, the electrode assembly which promotes the charge exchange reaction is included, and therefore, an all-solid state secondary battery capable of obtaining high output energy can be provided. Further, the active material portion constituting the electrode assembly contains a transition metal oxide but does not contain a sulfide, and therefore, in the production of the all-solid state secondary battery, a problem such as the generation of a toxic gas or an increase in the resistance of the electrode layer derived from the sulfide does not occur.

In the all-solid state secondary battery according to the application example, it is preferred that the positive electrode layer includes the electrode assembly according to the application example.

According to this configuration, an all-solid state secondary battery capable of obtaining a high output power and also capable of being charged in a short time can be provided.

### Application Example

A method for producing an electrode assembly according to this application example is a method for producing an electrode assembly to be used in an all-solid state secondary battery, and includes an orientation treatment step of subjecting a mixture containing a transition metal oxide in the form of particles as an active material and a binder to an orientation treatment, thereby orienting the crystal plane (hkl) of the transition metal oxide to the (001) plane, a sintering step of subjecting the mixture having been subjected to the orientation treatment to a heat treatment, thereby forming a porous active material portion, and a combining step of mixing the active material portion and a powder of a solid electrolyte portion containing an ion conductive solid at a predetermined ratio, subjecting the resulting mixture to a heat treatment at a temperature not lower than the melting point of the solid electrolyte portion, and cooling the mixture in a state where part of the molten solid electrolyte portion is made to penetrate into gaps of the active material portion, thereby combining the active material portion and the solid electrolyte portion with each other. Incidentally, h, k, and l which represent the crystal plane (hkl) are each a positive integer.

According to this application example, in the orientation treatment step, the direction of the orientation of the crystal plane in the particle of the transition metal oxide is controlled, and in the sintering step, in a state where the direction of the orientation of the crystal plane is controlled, the particles of the transition metal oxide are sintered, whereby the porous active material portion is formed. In the combining step, the molten solid electrolyte portion is made to penetrate into gaps of the porous active material portion, and then cooled, and therefore, in the gaps of the active material portion, the crystal plane orientation of an electrode reaction site where the electrode reaction activity of the transition metal oxide is high and the crystal plane orientation of an ion diffusion plane of the ion conductive solid can be made to substantially coincide with each other. Therefore, a method for producing an electrode assembly which promotes the charge exchange reaction and can realize an all-solid state secondary battery capable of obtaining high output energy can be provided.

In the method for producing an electrode assembly according to the application example, it is preferred that the solid electrolyte portion contains the ion conductive solid in at least an amount by mass capable of filling most of the gaps of the active material portion.

According to this method, almost all the gaps of the porous active material portion are filled with the solid electrolyte portion, and therefore, a method for producing an electrode assembly which can realize an all-solid state secondary battery having a high electric capacity density and also capable of obtaining high output energy can be provided.

In the method for producing an electrode assembly according to the application example, it is preferred that the transition metal oxide contains Li (lithium) and Co (cobalt), the ion conductive solid contains Li (lithium), B (boron), C (carbon) and O (oxygen), and in the combining step, the heat treatment is performed at a temperature of 680° C. or higher and 720° C. or lower for a treatment time of 2 minutes or more and 30 minutes or less.

When the ion conductive solid is melted, LiON or LiOH.H₂O (hydrate) is generated. LiOH or LiOH.H₂O (hydrate) reacts with the transition metal oxide to produce an insulating material. Therefore, according to this method, the temperature and the time in the combining step are controlled, and a problem such as an increase in the resistance of the electrode derived from an insulating material produced as a by-product can be suppressed.

In the method for producing an electrode assembly according to the application example, it is preferred that in the combining step, the heat treatment is performed in a carbon dioxide atmosphere.

According to this method, LiOH generated when the ion conductive solid is melted reacts with carbon dioxide gas and is converted to lithium carbonate. That is, LiOH which is a by-product is difficult to remain, and therefore, for example, a problem such as an increase in the resistance of the electrode derived from LiOH is further reduced.

### BRIEF DESCRIPTION OF THE DRAWINGS

The invention will be described with reference to the accompanying drawings, wherein like numbers reference like elements.

FIG. 1 is a schematic perspective view showing a structure of a lithium battery.

FIG. 2 is a schematic view showing the direction of the orientation of a crystal plane of an active material portion in a positive electrode layer.

FIG. 3 is a schematic cross-sectional view showing a relationship between the crystal plane orientation of an active material portion and the crystal plane orientation of a solid electrolyte portion.

FIG. 4 is a schematic view showing a crystal structure of a transition metal oxide.

FIG. 5 is a process chart showing an orientation treatment step.

FIG. 6 is a process chart showing a combining step.

FIG. 7 is a process chart showing a polishing step.

FIG. 8 is a process chart showing a current collector forming step.

FIG. 9 shows an X-ray diffraction line profile of a crystal plane in an active material portion of Example 1.

FIG. 10 shows an X-ray diffraction line profile of a crystal plane in a solid electrolyte portion of Example 1.

FIG. 11 is a schematic perspective view showing a structure of an all-solid state secondary battery of Modification Example 1.

### DESCRIPTION OF EXEMPLARY EMBODIMENTS

Hereinafter, embodiments embodying the invention will be described with reference to the accompanying drawings. The drawings to be used are displayed by appropriately enlarging or reducing the size so as to make portions to be described recognizable.

### All-Solid State Secondary Battery

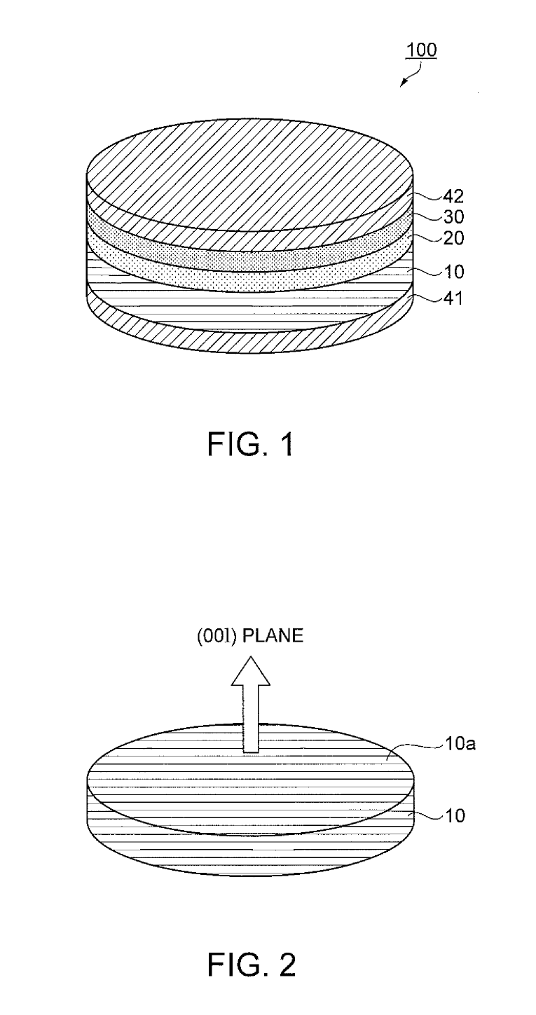

An all-solid state secondary battery of this embodiment will be described with reference to FIG. 1. In this embodiment, a lithium battery including a solid electrolyte layer will be described as an example of the all-solid state secondary battery. FIG. 1 is a schematic perspective view showing a structure of the lithium battery.

As shown in FIG. 1, a lithium battery 100 as the all-solid state secondary battery of this embodiment includes a positive electrode layer 10, a negative electrode layer 30, and a separator 20 provided between the positive electrode layer 10 and the negative electrode layer 30. The lithium battery 100 further includes a current collector 41 provided on the surface on the opposite side to the surface in contact with the separator 20 of the positive electrode layer 10 and a current collector 42 provided on the surface on the opposite side to the surface in contact with the separator 20 of the negative electrode layer 30. That is, the lithium battery 100 is configured to provide the current collectors 41 and 42 to a stacked body composed of the positive electrode layer 10, the separator 20, and the negative electrode layer 30.

The lithium battery 100 of this embodiment is, for example, in the shape of a disk, and as for the size of the outer shape thereof, for example, the diameter is 10 mm, and the thickness is, for example, 0.08 mm. The lithium battery 100 is small and thin, and also can be charged and discharged, and is capable of obtaining high output energy, and therefore can be favorably used as a power supply for portable information terminals such as smartphones. The shape of the lithium battery 100 is not limited to a disk shape, and may be a polygonal plate shape.

The positive electrode layer 10 is one example of the electrode assembly according to the invention, and includes an active material portion which contains a transition metal oxide as an active material, and a solid electrolyte portion which is in contact with the active material portion and contains an ion conductive solid, and is produced so that the crystal plane orientation of an electrode reaction site of the transition metal oxide and the crystal plane orientation of an ion diffusion plane of the ion conductive solid substantially coincide with each other. A detailed configuration and a production method of the positive electrode layer 10 will be described later.

The separator 20 is provided between the positive electrode layer 10 and the negative electrode layer 30, and is a solid electrolyte layer which mediates the conduction of a lithium ion while maintaining electrical insulation between these electrode layers. As a solid electrolyte having ion conductivity, any of oxides, sulfides, nitrides, and hydrides such as Li_{6.75}La₃Zr_{1.75}Nb_{0.25}O₁₂, SiO₂—SiO₂—P₂O₅—Li₂O, SiO₂—P₂O₅—LiCl, Li₂O—LiCl—B₂O₃, Li_{3.4}V_{0.6}Si_{0.4}O₄, Li₁₄ZnGe₄O₁₆, Li_{3.6}V_{0.4}Ge_{0.6}O₄, Li_{1.3}Ti_{1.7}Al_{0.3} (PO₄)₃, Li_{2.88}PO_{3.73}N_{0.14}. LiNbO₃, Li_{0.35}La_{0.55}TiO₃, Li₂S—SiS₂, Li₂S—SiS₂—LiI, Li₂S—SiS₂—P₂S₅, Li₃N, LiI, LiI—CaI₂, LiI—CaO, LiAlCl₄, LiAlF₄, LiI—Al₂O₃, LiF—Al₂O₃, LiBr—Al₂O₃, Li₂O—TiO₂, La₂O₃—Li₂O—TiO₂, Li₃NI₂, Li₃N—LiI—LiOH, Li₃N—LiCl, Li₆NBr₃, LiSO₄, Li₄SiO₄, Li₃PO₄—Li₄SiO₄, Li₄GeO₄—Li₃VO₄, Li₄SiO₄—Li₃VO₄, Li₄GeO₄—Zn₂GeO₂, Li₄SiO₄—LiMoO₄, Li₃PO₄—Li₄SiO₄, Li₄SiO₄—Li₃zrO₄, LiBH₄, Li₇PS₆₋ₓClₓ, and Li₁₀GeP₂S₁₂, or crystalline materials, amorphous materials, and partially crystallized glasses of partially substituted compounds thereof can be favorably used. In addition, it is also possible to contain two or more solid electrolytes as described. A material in which fine particles of an insulating material such as Al₂O₃, SiO₂, or ZrO₂ are combined in the solid electrolyte can also be used according to need.

Examples of a method for forming the separator 20 include solution processes such as a so-called sol-gel method involving a hydrolysis reaction or the like of an organic metal compound and an organic metal thermal decomposition method, and other than these, a CVD method using an appropriate metal compound and an appropriate gas atmosphere, an ALD method, a green sheet method using a slurry of solid electrolyte particles, a screen printing method, an aerosol deposition method, a sputtering method using an appropriate target and an appropriate gas atmosphere, a PLD method, and a flux method using a melt or a solution, and any of these methods may be used.

The thickness of the separator 20 obtained as described above is preferably from 50 nm to 100 μm, but can be set to a desired value according to the characteristics of the material or a design. Further, on a surface on the negative electrode layer 30 side of the separator 20 formed, an irregular structure such as a trench, a grating, or a pillar can also be provided according to need by combining various molding methods and working methods. In addition, the separator 20 is not only configured to have a single layer structure, but also can be configured to have a multilayered structure in which, for example, a glass electrolyte layer is formed on the surface of a layer formed from a crystalline material or the like for the purpose of preventing a short circuit.

The negative electrode layer 30 may contain a negative electrode active material. Examples of the negative electrode active material include Nb₂O₅, V₂O₅, TiO₂, In₂O₃, ZnO, SnO₂, NiO, ITO (Sn-doped indium oxide), AZO (aluminum-doped zinc oxide), GZO (gallium-doped zinc oxide), ATO (antimony-doped tin oxide), FTO (fluorine-doped tin oxide), anatase-type TiO₂, lithium multiple oxides such as Li₄Ti₅O₁₂ and Li₂Ti₃O₇, metals and alloys such as Si, Sn, Si—Mn, Si—Co, and Si—Ni, a carbon material, and a material obtained by intercalating lithium ions into layers of a carbon material (such as LiC₂₄ and LiC₆), and any of these materials can be used.

Examples of a method for forming the negative electrode layer 30 include solution processes such as a so-called sol-gel method involving a hydrolysis reaction or the like of an organic metal compound and an organic metal thermal decomposition method, and other than these, a CVD method using an appropriate metal compound and an appropriate gas atmosphere, an ALD method, a green sheet method using a slurry of a solid negative electrode active material, a screen printing method, an aerosol deposition method, a sputtering method using an appropriate target and an appropriate gas atmosphere, a PLD method, a vacuum deposition method, plating, and spraying, and any of these methods may be used.

The thickness of the negative electrode layer 30 obtained as described above is preferably from 50 nm to 100 μm, but can be arbitrarily set according to a desired battery capacity or the characteristics of the material.

As the material of the current collectors 41 and 42, any material can be favorably used as long as it is a material which does not electrochemically react with the positive electrode layer 10 or the negative electrode layer 30, and has electron conductivity. Examples of the material include one type of metal (a metal simple substance) selected from the group consisting of Cu, Mg, Ti, Fe, Co, Ni, Zn, Al, Ge, In, Au, Pt, Ag, and Pd, an alloy or the like containing two or more types of metal elements selected from this group, an electrically conductive metal oxide such as ITO, ATO, and FTO, and a metal nitride such as TiN, ZrN, and TaN.

Examples of the form of the current collectors 41 and 42 include a thin film of the above-mentioned material having electron conductivity, and other than this, a metal foil, a plate, and a paste obtained by kneading an electrically conductive fine powder along with a binder, and a user can select an appropriate form according to the intended purpose. Examples of a forming method thereof include a method in which an appropriate adhesive layer is separately provided to effect adhesion thereof, and other than this, gas phase deposition methods such as a vacuum deposition method, a CVD method, a PLD method, an ALD method, and an aerosol deposition method, and wet methods such as a sol-gel method, an organic metal thermal decomposition method, and plating, and an appropriate method can be used according to the reactivity with the surface on which the current collector is formed, desired electrical conductivity for an electric circuit, and the design of the electric circuit.

The current collectors 41 and 42 are formed according to need, however, for example, in the case where an electrode layer is formed on an electrically conductive substrate and combined therewith, or the like, it is not necessary to form the current collector on both of the positive electrode layer 10 and the negative electrode layer 30. Further, the current collectors 41 and 42 may be formed after forming a stacked body of the positive electrode layer 10, the separator 20, and the negative electrode layer 30, or before forming the stacked body.

### Electrode Assembly

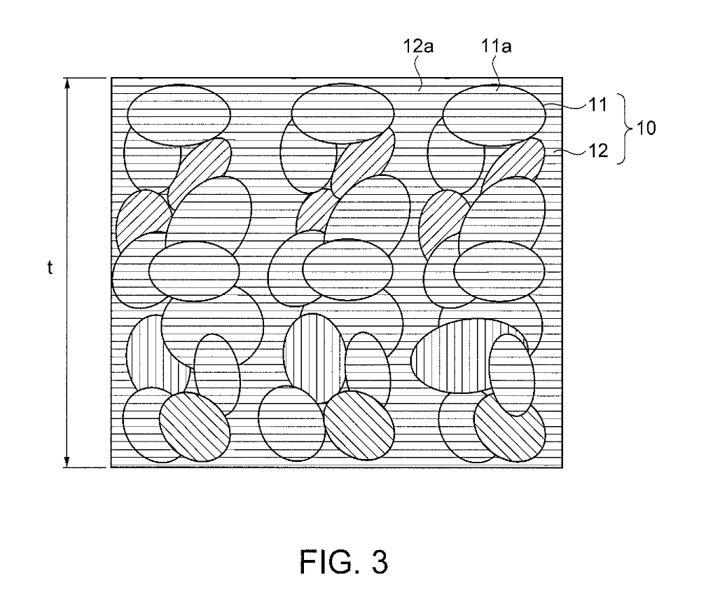

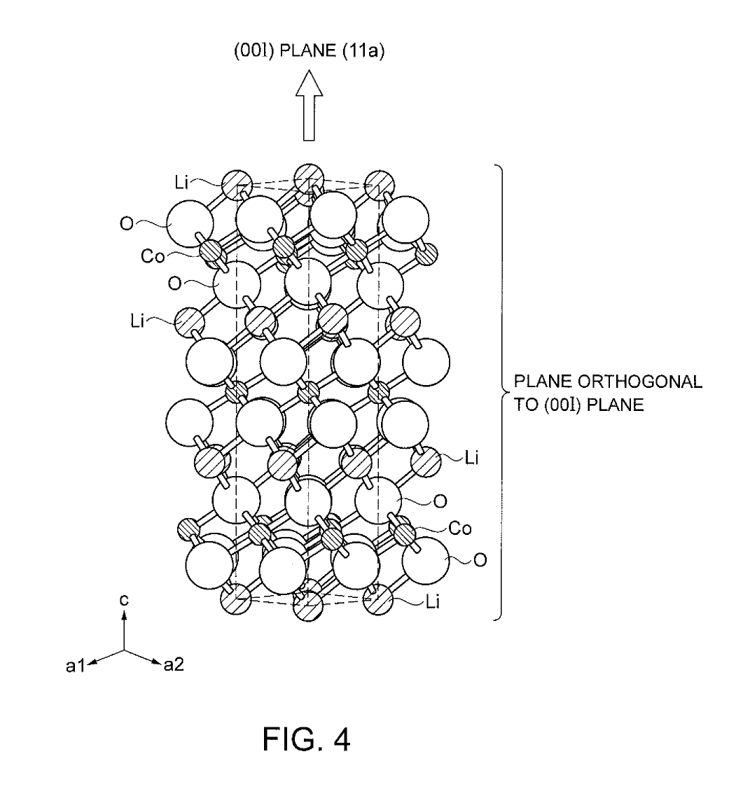

Next, the electrode assembly of this embodiment will be described with reference to FIGS. 2 to 4. FIG. 2 is a schematic view showing the direction of the orientation of the crystal plane of the active material portion in the positive electrode layer, FIG. 3 is a schematic cross-sectional view showing a relationship between the crystal plane orientation of the active material portion and the crystal plane orientation of the solid electrolyte portion, and FIG. 4 is a schematic view showing the crystal structure of a transition metal oxide.

The positive electrode layer 10 which is one example of the electrode assembly of this embodiment includes the active material portion containing a transition metal oxide as an active material and the solid electrolyte portion containing an ion conductive solid. Further, the active material portion and the solid electrolyte portion are formed in contact with each other.

Preferred examples of the active material include a compound having a layered crystal structure assigned to the space group R3m among the transition metal oxides such as LiCoO₂ and LiNiO₂. Further, the transition metal oxide may contain a transition metal such as Mn, Cu, Zr, La, or Ce other than Co or Ni, or a metal such as Al or Er.

The solid electrolyte portion contains an ion conductive solid, that is, a solid electrolyte having ion conductivity, and examples of the solid electrolyte having ion conductivity include the above-mentioned materials shown for the separator 20.

As shown in FIG. 2, on the positive electrode layer 10 of this embodiment, the crystal plane (hkl) of the transition metal oxide of the active material portion and the crystal plane (hkl) of the ion conductive solid are both (001)-oriented. The surface 10a orthogonal to the thickness direction of the positive electrode layer 10 is a (001) plane. Incidentally, h, k, and l are each an arbitrary integer.

Specifically, as shown in FIG. 3, the positive electrode layer 10 includes an active material portion 11 and a solid electrolyte portion 12. The active material portion 11 is a porous body obtained by performing an orientation treatment of controlling the direction of the orientation of the crystal plane 11a in the transition metal oxide in the form of particles and performing sintering so that the crystal plane 11a of the transition metal oxide is orthogonal to the thickness direction t of the positive electrode layer 10. The solid electrolyte portion 12 is formed so as to fill the gaps of the porous active material portion 11, and the crystal plane 12a of the ion conductive solid contained in the solid electrolyte portion 12 is also orthogonal to the thickness direction t. In FIG. 3, the crystal plane 11a of the transition metal oxide and the crystal plane 12a of the ion conductive solid are indicated in stripes. Although it depends on the state of the orientation treatment, the crystal plane 11a of the transition metal oxide is not necessarily oriented in a given direction in all the particles, and a particle having a crystal plane which is oriented in a different direction from the given direction is contained partially.

For example, when LiCoO₂ is taken as an example of the transition metal oxide, as shown in FIG. 4, the crystal structure of LiCoO₂ is a layered structure in which a layer of lithium (Li) and a layer of cobalt (Co) are alternately stacked between layers in which oxygen (O) and oxygen (O) are arranged in the plane of lattice axes (a1, a2) in the direction of the c-lattice axis. In other words, it is a structure in which the octahedral sites of the respective layers of the cubic close-packed structure of oxygen (O) are alternately occupied by Li and Co, and the tetrahedral site of oxygen (O) is empty. That is, the crystal plane 11a of LiCoO₂ is (003)-oriented. In such a layered structure, the diffusion direction of a Li ion, that is, the electrode reaction site where charge exchange is performed is a direction orthogonal to the crystal plane ha. In other words, the crystal plane orientation which is a normal direction with respect to the crystal plane 11a ((003) plane) of LiCoO₂ as the transition metal oxide coincides with the thickness direction of the positive electrode layer 10.

On the other hand, for example, when Li_{2.2}C_{0.8}B_{0.2}O₃ is taken as an example of the ion conductive solid, the crystal structure of Li_{2.2}C_{0.8}B_{0.2}O₃ is also a layered structure, and the crystal plane 12a is (002)-oriented. Therefore, the diffusion direction of a Li ion, that is, the electrode reaction site where charge exchange is performed is a direction orthogonal to the crystal plane 12a. In other words, the crystal plane orientation of the crystal plane 12a ((002) plane) of Li_{2.2}C_{0.8}B_{0.2}O₃ as the ion conductive solid coincides with the thickness direction of the positive electrode layer 10. Therefore, in the positive electrode layer 10, the crystal plane orientation of the transition metal oxide and the crystal plane orientation of the ion conductive solid coincide with each other, and the active material portion 11 and the solid electrolyte portion 12 are in contact with each other, and thus, the positive electrode layer 10 has a structure in which charge exchange is smoothly performed. In addition, the positive electrode layer 10 has a structure in which the active material portion 11 and the solid electrolyte portion 12 are in contact with each other in the gaps of the active material portion 11 which is a porous body, and therefore, a state where the electric capacity density is high is realized.

Method for Producing Electrode Assembly

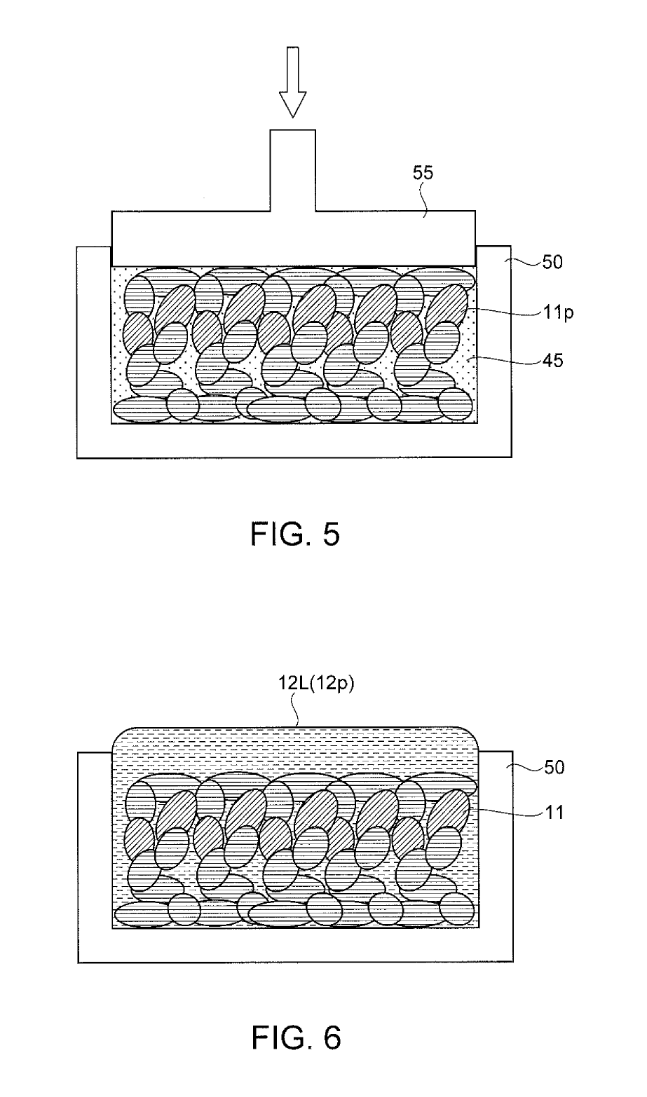

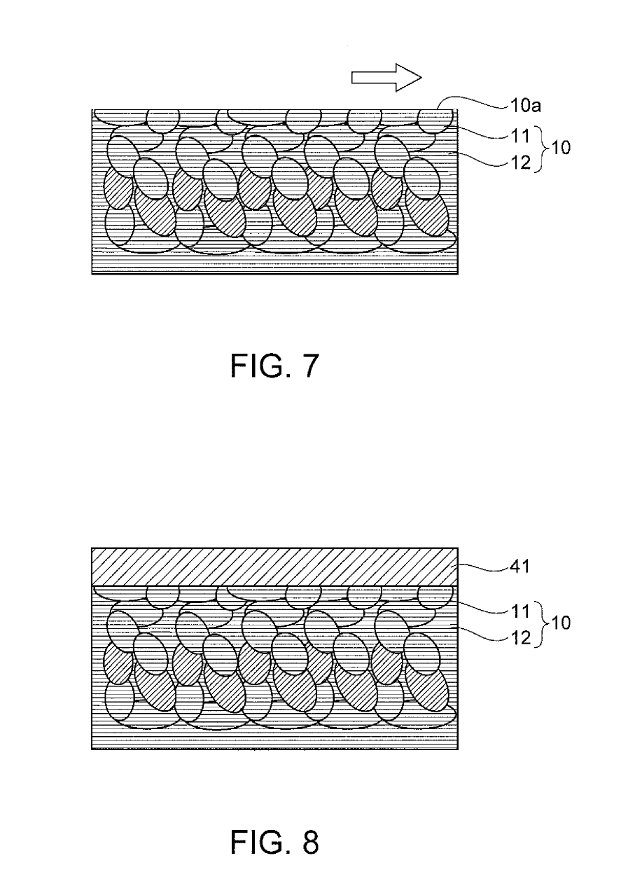

Next, as one example of a method for producing an electrode assembly of this embodiment, a method for producing the positive electrode layer 10 will be described with reference to FIGS. 5 to 8. FIG. 5 is a process chart showing an orientation treatment step, FIG. 6 is a process chart showing a combining step, FIG. 7 is a process chart showing a polishing step, and FIG. 8 is a process chart showing a current collector forming step.

The method for producing the positive electrode layer 10 in the electrode assembly of this embodiment includes an orientation treatment step of orienting the crystal plane 11a in the particle of the transition metal oxide to a given direction, a sintering step of subjecting the particles of the transition metal oxide having been subjected to the orientation treatment to a heat treatment, thereby forming the porous active material portion 11, a combining step of mixing the porous active material portion 11 and a powder of the solid electrolyte portion 12 at a predetermined ratio, subjecting the resulting mixture to a heat treatment at a temperature not lower than the melting point of the solid electrolyte portion 12, and cooling the mixture in a state where the molten solid electrolyte portion 12 is made to penetrate into the gaps of the active material portion 11, thereby combining the active material portion 11 and the solid electrolyte portion 12 with each other, a polishing step of polishing the surface of the combined material, and a current collector forming step of forming the current collectors 41 and 42 on the surface of the polished combined material.

Specifically, in the orientation treatment step, as shown in FIG. 5, a mixture containing particles 11p of a transition metal oxide and a binder 45 is filled in a mold 50, and the mixture is compressed by applying pressure by a pressing portion 55. By doing this, the particles 11p of the transition metal oxide are compressed so that the crystal plane orientation of the transition metal oxide is aligned in the direction in which pressure is applied to the mixture. That is, the mixture containing the particles 11p of the transition metal oxide whose crystal plane orientation is not uniform is subjected to an orientation treatment. The method of the orientation treatment is not limited to a method in which pressure is applied to the mixture from a given direction, and a method in which the mixture is dried in a magnetic field, or a method in which these methods are combined may be adopted.

In the sintering step, the mold 50 in which the mixture having been subjected to the orientation treatment is placed is heated at, for example, 1000° C. for about 8 hours. By doing this, the binder 45 contained in the mixture is burned off, and gaps (pores) are formed in the inside, whereby the active material portion 11 which is a disk-shaped porous sintered body (porous body) is obtained. Examples of the binder 45 to be used for forming such a porous body include polyvinylidene fluoride (PVdF), polyvinyl alcohol (PVA), polyacrylic acid, and polypropylene carbonate (PPC).

The bulk density porosity of the porous active material portion 11 can be determined according to the following formula (1).

Bulk density porosity (%)=[1−(mass of active material molded body)/(apparent volume)×(theoretical density of active material)]×100 (1)

As described above, the bulk density porosity of the active material portion 11 is preferably 35% or more and 60% or less. When the bulk density porosity is less than 35%, it is difficult to realize a high capacity density, and when the bulk density porosity exceeds 60%, the mechanical strength of the active material portion 11 may be poor. Therefore, in this embodiment, in order to obtain the active material portion 11 having a bulk density porosity of 50% in consideration of a variation in the processing conditions in the orientation treatment and sintering, the particles 11p of the transition metal oxide in which the particle size is adjusted so as to obtain a particle size distribution ranging from 5 μm to 25 μm are used. In the porous active material portion 11 formed in this manner, gaps (pores) in a state where the gaps communicate with each other are present more than in a state where the gaps are isolated from each other, and therefore, it becomes easy to fill the gaps communicating with each other with the solid electrolyte portion 12 in the subsequent step. Incidentally, the gaps are in a state of communicating with each other not only in a surface layer but also in a deep portion of the active material portion 11.

In the combining step, in the active material portion 11 placed in the mold 50, a powder 12p of the ion conductive solid is mixed, and the powder 12p is melted by heating the mold 50 at a temperature not lower than the melting point of the ion conductive solid. The ratio of the powder 12p of the ion conductive solid to the active material portion 11 is set to a mass ratio so as to be able to sufficiently fill the gaps of the porous active material portion 11.

As shown in FIG. 6, a melt 12L of the powder 12p penetrates into the gaps of the porous active material portion 11. By stopping the heating of the mold 50 and cooling the mold 50, the active material portion 11 and the solid electrolyte portion 12 are combined with each other in a state where the gaps of the active material portion 11 are filled with the ion conductive solid. Since the crystal plane orientation of the active material portion 11 is aligned, the melt 12L filled in the gaps of the active material portion 11 is solidified in the same phase as that of the crystal plane of the active material portion 11 in the cooling process. That is, the active material portion 11 and the solid electrolyte portion 12 are combined with each other in a state where the crystal plane orientation of the transition metal oxide of the active material portion 11 and the crystal plane orientation of the ion conductive solid of the solid electrolyte portion 12 substantially coincide with each other.

When the powder 12p of the ion conductive solid is melted, LiOH (lithium hydroxide) or LiOH.H₂O (hydrate of lithium hydroxide) is generated. When LiOH remains in the positive electrode layer 10, LiOH reacts with the transition metal oxide to produce an insulating material as a by-product, and the electrical resistance of the positive electrode layer 10 may be increased. Therefore in this embodiment, the combining step is performed in a carbon dioxide atmosphere. By performing the step in a carbon dioxide atmosphere, the generated LiOH is converted to Li₂CO₃ (lithium carbonate) according to the following chemical reaction formula (1), and thus, the increase in the electrical resistance of the positive electrode layer 10 is suppressed.

2LiOH+CO₂→Li₂CO₃+H₂O(↑) (1)

In the polishing step, as shown in FIG. 7, one surface of the combined material is polished, whereby the positive electrode layer 10 having a surface 10a on which the active material portion 11 is exposed is formed. In the current collector forming step, as shown in FIG. 8, the current collector 41 is formed on the surface 10a of the positive electrode layer 10. By doing this, the current collector 41 and the active material portion 11 are reliably bonded to each other. If the active material portion 11 is exposed on the surface of the combined material at a stage when the active material portion 11 and the solid electrolyte portion 12 are combined, it is not necessary to perform the polishing step.

Next, by showing specific Example and Comparative Example of the lithium battery 100 to which the positive electrode layer 10 as the electrode assembly according to the invention is applied, the effect of Example will be described.

### Example 1

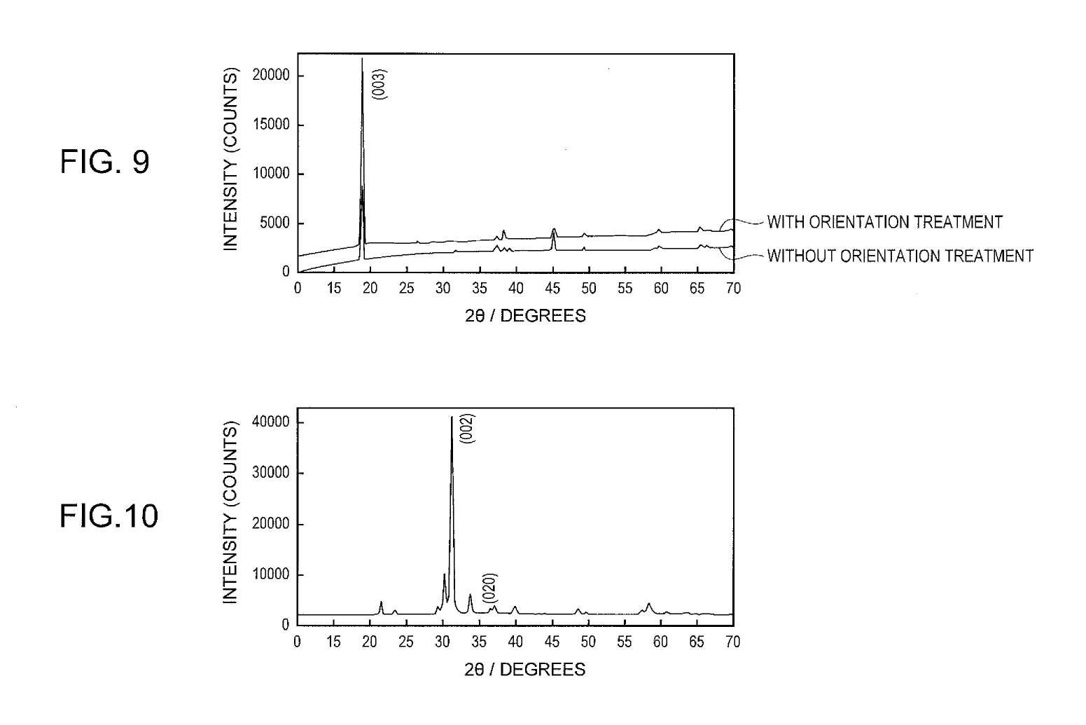

1. Orientation Treatment and Sintering Step: In Example 1, a powder of LiCoO₂ having a median diameter in a particle size distribution of about 20 μm was used as the transition metal oxide which is the positive electrode active material. With respect to the powder of LiCoO₂, 3.5 parts by weight of polyacrylic acid having an average molecular weight of 20000 as the binder was mixed, and thereafter, the resulting mixture was filled in a die (mold 50) provided with an exhaust port having an inner diameter of 10 mm and pressed at 350 MPa (megapascal) for 2 minutes, followed by firing in an air atmosphere at 1000° C. for 8 hours. By doing this, a porous body in which the particles of LiCoO₂ were subjected to an orientation treatment and sintered was obtained. In order to confirm the crystal orientation of the obtained disk-shaped porous body, when an XRD diffraction line intensity ratio was measured by a thin-film X-ray diffractometer (manufactured by Philips Corporation), as shown in FIG. 9, a diffraction profile which shows that the crystal of LiCoO₂ was strongly oriented to the (003) plane with respect to the thickness direction of the porous body was obtained. Further, the bulk density porosity of this porous body was 54%. By the above-mentioned steps, a disk-shaped porous body in which the crystal plane of the (003) plane in the crystal of LiCoO₂ is oriented in the thickness direction was obtained.

2. Combining Step: Subsequently, a powder of Li_{2.2}C_{0.8}B_{0.2}O₃ which is the solid electrolyte was placed on the surface of the porous body, and the molten state was maintained at 700° C. for 3 minutes, thereby allowing molten Li_{2.2}C_{0.8}B_{0.2}O₃ to penetrate into the gaps in the inside of the porous body, followed by cooling, whereby a combined material was obtained. Such a combining step is performed in a carbon dioxide atmosphere as described above. Incidentally, by performing the combining procedure in an air atmosphere, and thereafter placing the combined material in a carbon dioxide atmosphere and maintaining the temperature at 630° C. or higher for 20 minutes, a decomposed material generated from the solid electrolyte may be restored to Li_{2.2}C_{0.8}B_{0.2}O₃. By this procedure, the positive electrode layer 10 (electrode assembly) in which 93% of the volume of the gaps of the porous material was filled with Li_{2.2}C_{0.8}B_{0.2}O₃ was obtained. Incidentally, when the heat treatment temperature in the combining step is too low or the heat treatment time is too short, a sufficient amount of Li_{2.2}C_{0.8}B_{0.2}O₃ does not penetrate into the gaps in the inside of the porous body, however, when the heat treatment temperature is too high or the heat treatment time is too long, contamination with LiOH or LiOH.H₂O is easy to occur due to thermal decomposition, and therefore, the heat treatment temperature is preferably 680° C. or higher and 720° C. or lower, more preferably 685° C. or higher and 700° C. or lower. Further, the heat treatment time is preferably 2 minutes or more and 30 minutes or less, more preferably 3 minutes or more and 15 minutes or less.

In order to confirm the crystal orientation of Li_{2.2}C_{0.8}B_{0.2}O₃ contained in the positive electrode layer 10 of Example 1, when an XRD diffraction line intensity ratio was measured by the thin-film X-ray diffractometer, a diffraction profile as shown in FIG. 10 was obtained. According to the diffraction profile shown in FIG. 10, the intensity ratio (P₀₂₀:P₀₀₂) of the integrated area intensity P₀₂₀ of the diffraction line of the (020) plane to the integrated area intensity P₀₀₂ of the diffraction line of the (002) plane was 1:38. Further, a diffraction profile which shows that the crystal of Li_{2.2}C_{0.8}B_{0.2}O₃ was oriented to the (002) plane with respect to the thickness direction of the positive electrode layer 10 (electrode assembly) was obtained.

3. Separator Forming Step: By performing sputtering in a nitrogen atmosphere using a sintered body of Li₃PO₄ as a target, a thin film (having a film thickness of about 700 nm) of LiPON (lithium phosphorus oxynitride) was formed as the solid electrolyte on one surface of the positive electrode layer 10 molded into a disk shape, whereby the separator 20 was formed.

4. Negative Electrode Forming Step: On the surface of the thus formed solid electrolyte layer, a Li metal thin film (having a film thickness of about 2 μm) was formed by vacuum deposition, whereby the negative electrode layer 30 was formed.

5. Current Collector Forming Step: On the surface of each of the positive electrode layer 10 and the negative electrode layer 30, a film of Pt (platinum) was formed such that the film thickness was about 120 nm, whereby the current collectors 41 and 42 were formed.

The lithium battery 100 of Example 1 obtained by the above-mentioned steps was connected to a multi-channel charge-discharge evaluation apparatus (manufactured by Hokuto Denko Corporation), and a charge-discharge test was performed in a range of 3.0 V to 4.2 Vat room temperature. At this time, the discharge capacity was 120 rah/g, and the maximum instantaneous discharge rate was 4 C.

### Comparative Example 1

1. Active Material Portion Forming Step: A fine particle mixture containing 55 parts by weight of particles of LiCoO₂ and 45 parts by weight of particles of Li_{2.2}C_{0.8}B_{0.2}O₃ was prepared, and a 25 wt % PPC solution in which polypropylene carbonate (PPC) was dissolved in 1,4-dioxane was added in an equal weight to that of the fine particle mixture. The resulting mixture was ground with a ball mill in an argon gas atmosphere for 8 hours, whereby a dispersion slurry was obtained. This dispersion slurry was applied to a substrate of polyethylene terephthalate (PET), followed by drying in an argon gas atmosphere at 90° C. The resulting dried material was released from a mold and processed into a disk shape, and then, fired in an air atmosphere at 1000° C. for 8 hours. As a result, a sintered body having an average bulk density porosity of 55% was obtained. When the orientation of the crystals of LiCoO₂ contained in this sintered body was analyzed based on an XRD diffraction line intensity ratio using the thin-film X-ray diffractometer, most of the crystals of LiCoO₂ did not have orientation.

2. Combining Step: Subsequently, a powder of Li_{2.2}C_{0.8}B_{0.2}O₃ which is the solid electrolyte was placed on the surface of the sintered body of LiCoO₂ formed by the above-mentioned active material portion forming step, and the molten state was maintained at 700° C. for 3 minutes, thereby allowing Li_{2.2}C_{0.8}B_{0.2}O₃ to penetrate into the gaps in the inside of the sintered body, whereby a combined material was obtained. Subsequently, the combined material was maintained in a carbon dioxide atmosphere at 630° C. or higher for 20 minutes, whereby a decomposed material generated from the solid electrolyte was restored to Li_{2.2}C_{0.8}B_{0.2}O₃. By this procedure, a positive electrode layer in which 93% of the volume of the gaps in the inside of the sintered body was filled with Li_{2.2}C_{0.8}B_{0.2}O₃ was obtained.

In order to confirm the crystal orientation of Li_{2.2}C_{0.8}B_{0.2}O₃ contained in the positive electrode layer of Comparative Example 1 described above, when an XRD diffraction line intensity ratio (P₀₂₀:P₀₀₂) was measured by the thin-film X-ray diffractometer in the same manner as in Example 1, the intensity ratio (P₀₂₀:P₀₀₂) was 1:5.3. Further, it was found that the orientation of the crystal of Li_{2.2}C_{0.8}B_{0.2}O₃ was small.

The separator forming step, the negative electrode layer forming step, and the current collector forming step in Comparative Example 1 are the same as those in Example 1.

The lithium battery of Comparative Example 1 obtained by the above-mentioned steps was connected to a multi-channel charge-discharge evaluation apparatus (manufactured by Hokuto Denko Corporation), and a charge-discharge test was performed in a range of 3.0 V to 4.2 V at room temperature in the same manner as in Example 1. At this time, the discharge capacity was 8.4 mAh/g, and the maximum instantaneous discharge rate was 0.06 C.

According to Example 1, the crystal plane orientation of LiCoO₂ of the active material portion 11 and the crystal plane orientation of Li_{2.2}C_{0.8}B_{0.2}O₃ of the solid electrolyte portion 12 can be made to substantially coincide with each other. The lithium battery 100 having a higher discharge capacity and a higher discharge rate as compared with Comparative Example 1, in which the crystal plane orientation is not controlled, is realized. An all-solid state secondary battery has almost no electrode surface adhesion capacity (so-called capacitor capacity), and therefore, if a battery has a discharge rate of 1 C or more, it is acceptable to say that the battery is of sufficiently high output type. Further, with respect to the crystal plane orientation of Li_{2.2}C_{0.8}B_{0.2}O₃ of the solid electrolyte portion 12, from the viewpoint of evaluating the coincidence with the crystal plane orientation of LiCoO₂ of the active material portion 11, the intensity ratio (P₀₂₀:P₀₀₂) in the XRD diffraction line profile is preferably 1:20 or less.

According to the positive electrode layer 10 as the electrode assembly and the method for producing the same of the above-mentioned embodiments, the following effects are obtained.

(1) In the combining step, the melt 12L obtained by melting the powder 12P of the solid electrolyte portion 12 is made to penetrate into the porous active material portion 11, and then solidified by cooling in a state where the gaps of the active material portion 11 are filled with the melt 12L. The active material portion 11 has been subjected to the orientation treatment so that the crystal plane 11a of the transition metal oxide is orthogonal to the thickness direction t in the orientation treatment step. Therefore, the melt 12L is solidified in the gaps of the active material portion 11 so that the crystal plane 12a of the ion conductive solid and the crystal plane 11a of the transition metal oxide are in the same phase. According to this, the positive electrode layer 10 in which the active material portion 11 and the solid electrolyte portion 12 are combined with each other in a state where the crystal plane orientation of the transition metal oxide and the crystal plane orientation of the ion conductive solid substantially coincide with each other. That is, the positive electrode layer 10 includes the active material portion 11 containing the transition metal oxide and the solid electrolyte portion 12 containing the ion conductive solid, which are combined with each other such that the crystal plane orientation of the transition metal oxide and the crystal plane orientation of the ion diffusion plane of the ion conductive solid substantially coincide with each other. Since the crystal plane orientation of the transition metal oxide and the crystal plane orientation of the ion diffusion plane of the ion conductive solid substantially coincide with each other, the positive electrode layer 10 as the electrode assembly capable of allowing the electrode reaction in which charge exchange is performed to smoothly proceed can be provided or produced.

(2) The active material portion 11 is a porous body having a bulk density porosity of 35% or more and 60% or less, and therefore, the positive electrode layer 10 having a high electric capacity density can be provided.

(3) The positive electrode layer 10 uses a transition metal oxide as the positive electrode active material, and therefore, a toxic gas such as hydrogen sulfide is not generated in the process of production of the positive electrode layer 10, and therefore, the safety and health performance is excellent as compared with the case where a sulfide is used as the solid electrolyte as disclosed in PTL 1 described above.

(4) The lithium battery 100 as the all-solid state secondary battery to which the positive electrode layer 10 as the electrode assembly is applied allows the electrode reaction in the positive electrode layer 10 to smoothly proceed, can be charged and discharged, and also can take out high output energy.

The invention is not limited to the above-mentioned embodiments, and appropriate modifications are possible without departing from the gist or ideas of the invention readable from the appended claims and the entire specification. An electrode assembly thus modified, a method for producing the electrode assembly, and an all-solid state secondary battery to which the electrode assembly is applied are also included in the technical scope of the invention. Other than the above-mentioned embodiments, various modification examples can be made. Hereinafter, modification examples will be described.

### Modification Example 1

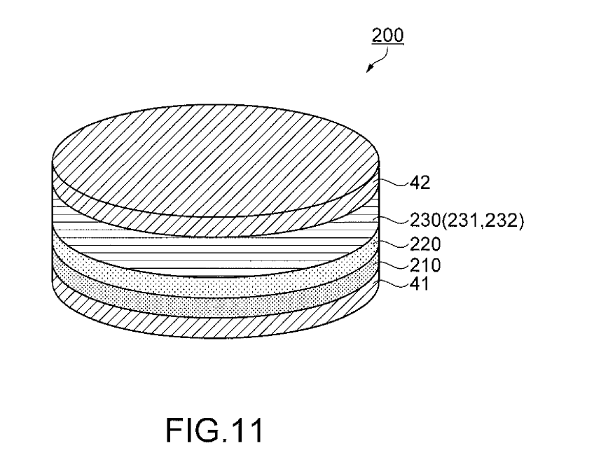

The electrode layer to which the electrode assembly and the method for producing the same according to the invention can be applied is not limited to the positive electrode layer 10. FIG. 11 is a schematic perspective view showing a structure of a lithium battery of Modification Example 1. In Modification Example 1, the same reference numerals are given to the same components as those of the lithium battery 100 of the above-mentioned embodiments, and a detailed description thereof will be omitted. As shown in FIG. 11, a lithium battery 200 as an all-solid state secondary battery of Modification Example 1 includes a stacked body of a positive electrode layer 210, a separator 220, and a negative electrode layer 230, and current collectors 41 and 42 provided to the stacked body. The positive electrode layer 210 is an electrode layer containing a positive electrode active material, and the separator 220 is a solid electrolyte layer formed using a solid electrolyte in the same manner as the separator 20 of the lithium battery 100 described above. The negative electrode layer 230 includes an active material portion 231 containing a negative electrode active material, and a solid electrolyte portion 232 which is contacted and combined with the active material portion 231. The active material portion 231 is a porous body, and part of the solid electrolyte portion 232 is filled in the gaps of the active material portion 231, thereby combining the active material portion 231 and the solid electrolyte portion 232 with each other, and the crystal plane orientation in the negative electrode active material of the active material portion 231 and the crystal plane orientation in the ion conductive solid of the solid electrolyte portion 232 substantially coincide with each other.

Examples of the active material portion 231 of the negative electrode layer 230 include compounds having a layered crystal structure such as graphite-type carbon, ramsdellite-type Li₂Ti₃O₇, TiO₂ (B) (bronze-type titanium oxide), and Li₄Nb₆O₁₇.

Examples of the solid electrolyte portion 232 include layered compounds such as La_{2/3-x}Li₃ₓ—TiO₃ having a tetragonal crystal structure.

By applying the electrode assembly and the method for producing the same according to the invention to the negative electrode layer 230, the lithium battery 200 of Modification Example 1 in which the electrode reaction smoothly proceeds, the electric capacity density is high, and high output energy is obtained can be realized. Further, since the negative electrode layer 230 includes the porous active material portion 231, even if a Li ion moves to the negative electrode layer 230 side during charging, a change in the volume can be suppressed.

### Modification Example 2

The method for orientation treatment of controlling the direction of the orientation of the crystal plane ha of the transition metal oxide in the active material portion 11 in the above-mentioned embodiments is not limited to the method by applying pressure. For example, a dispersion liquid in which 48 parts by weight of a powder of LiCoO₂ having the same particle diameter as in Example 1, 50 parts by weight of a 10 wt % to 25 wt % PPC solution in which PPC as a binder is dissolved in 1,4-dioxane, and 2 parts by weight of oleylamine as a dispersant are mixed is prepared as a slurry, and the slurry is subjected to a magnetic field orientation treatment at a magnetic field strength of, for example, 2 T (tesla) or more. The crystal plane ((003) plane, see FIG. 4) of LiCoO₂ which is the transition metal oxide is oriented along the direction of the magnetic field applied to the slurry. Therefore, the crystal plane is oriented by applying a magnetic field in the direction orthogonal to the thickness direction of the slurry. Then, by drying and sintering the slurry after being subjected to the magnetic field orientation treatment, a porous active material portion 11 can be formed. That is, a porous active material portion 11 in which the crystal plane of LiCoO₂ is oriented in the thickness direction is obtained.

### Modification Example 3

The all-solid state secondary battery to which the electrode assembly and the method for producing the same of the above-mentioned embodiments can be applied is not limited to the lithium battery 100 (or the lithium battery 200). The electrode assembly and the method for producing the same of the above-mentioned embodiments can also be applied to an all-solid state secondary battery including an electrode layer containing an active material constituted by an element other than Li.

1. An electrode assembly, which is an electrode assembly to be used in an all-solid state secondary battery, comprising:
an active material portion which contains a transition metal oxide as an active material; and
a solid electrolyte portion which is in contact with the active material portion and contains an ion conductive solid, wherein
the crystal plane orientation of the transition metal oxide and the crystal plane orientation of an ion diffusion plane of the ion conductive solid substantially coincide with each other.

2. The electrode assembly according to claim 1, wherein with respect to the thickness direction of the electrode assembly, the crystal plane (hkl) of the transition metal oxide and the crystal plane (hkl) of the ion conductive solid are both (001)-oriented.

3. The electrode assembly according to claim 2, wherein
the transition metal oxide contains Li (lithium) and Co (cobalt), and
the ion conductive solid contains Li (lithium), B (boron), C (carbon) and O (oxygen).

4. The electrode assembly according to claim 3, wherein the ratio (P₀₂₀:P₀₀₂) of the X-ray diffraction peak intensity P₀₂₀ in the (020) plane of the ion conductive solid to the X-ray diffraction peak intensity P₀₀₂ in the (002) plane thereof is 1:20 or less.

5. The electrode assembly according to claim 1, wherein the active material portion is a porous body, and part of the solid electrolyte portion is filled in gaps of the porous body, whereby the active material portion and the solid electrolyte portion are in contact with each other.

6. The electrode assembly according to claim 5, wherein the bulk density porosity of the active material portion is 35% or more and 60% or less.

7. An all-solid state secondary battery, comprising a positive electrode layer, a negative electrode layer, and a solid electrolyte layer sandwiched between the positive electrode layer and the negative electrode layer, wherein
at least one of the positive electrode layer and the negative electrode layer includes the electrode assembly according to claim 1.

8. An all-solid state secondary battery, comprising a positive electrode layer, a negative electrode layer, and a solid electrolyte layer sandwiched between the positive electrode layer and the negative electrode layer, wherein
at least one of the positive electrode layer and the negative electrode layer includes the electrode assembly according to claim 2.

9. An all-solid state secondary battery, comprising a positive electrode layer, a negative electrode layer, and a solid electrolyte layer sandwiched between the positive electrode layer and the negative electrode layer, wherein
at least one of the positive electrode layer and the negative electrode layer includes the electrode assembly according to claim 3.

10. An all-solid state secondary battery, comprising a positive electrode layer, a negative electrode layer, and a solid electrolyte layer sandwiched between the positive electrode layer and the negative electrode layer, wherein
at least one of the positive electrode layer and the negative electrode layer includes the electrode assembly according to claim 4.

11. An all-solid state secondary battery, comprising a positive electrode layer, a negative electrode layer, and a solid electrolyte layer sandwiched between the positive electrode layer and the negative electrode layer, wherein
at least one of the positive electrode layer and the negative electrode layer includes the electrode assembly according to claim 5.

12. An all-solid state secondary battery, comprising a positive electrode layer, a negative electrode layer, and a solid electrolyte layer sandwiched between the positive electrode layer and the negative electrode layer, wherein
at least one of the positive electrode layer and the negative electrode layer includes the electrode assembly according to claim 6.

13. The all-solid state secondary battery according to claim 7, wherein the positive electrode layer includes the electrode assembly to be used in the all-solid state secondary battery, comprising:
the active material portion which contains a transition metal oxide as the active material; and
the solid electrolyte portion which is in contact with the active material portion and contains the ion conductive solid, wherein
the crystal plane orientation of the transition metal oxide and the crystal plane orientation of the ion diffusion plane of the ion conductive solid substantially coincide with each other.

14. A method for producing an electrode assembly, which is a method for producing an electrode assembly to be used in an all-solid state secondary battery, comprising:
an orientation treatment step of subjecting a mixture containing a transition metal oxide in the form of particles as an active material and a binder to an orientation treatment, thereby orienting the crystal plane (hkl) of the transition metal oxide to the (001) plane;
a sintering step of subjecting the mixture having been subjected to the orientation treatment to a heat treatment, thereby forming a porous active material portion; and
a combining step of mixing the active material portion and a powder of a solid electrolyte portion containing an ion conductive solid at a predetermined ratio, subjecting the resulting mixture to a heat treatment at a temperature not lower than the melting point of the solid electrolyte portion, and cooling the mixture in a state where part of the molten solid electrolyte portion is made to penetrate into gaps of the active material portion, thereby combining the active material portion and the solid electrolyte portion with each other.

15. The method for producing an electrode assembly according to claim 14, wherein the solid electrolyte portion contains the ion conductive solid in at least an amount by mass capable of filling most of the gaps of the active material portion.

16. The method for producing an electrode assembly according to claim 14, wherein
the transition metal oxide contains Li (lithium) and Co (cobalt),
the ion conductive solid contains Li (lithium), B (boron), C (carbon) and O (oxygen), and
in the combining step, the heat treatment is performed at a temperature of 680° C. or higher and 720° C. or lower for a treatment time of 2 minutes or more and 30 minutes or less.

17. The method for producing an electrode assembly according to claim 16, wherein in the combining step, the heat treatment is performed in a carbon dioxide atmosphere.
